(19) United States
(12) Patent Application Publication
(10) Pub. No.: US 2006/0004879 A1
(43) Pub. Date: Jan. 5, 2006

(54) Data backup system and method

(75) Inventor: Minoru Tone, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 10/974,318

(22) Filed: Oct. 27, 2004

(30) Foreign Application Priority Data
May 28, 2004 (JP) 2004-158644

(51) Int. Cl. G06F 12/00

(52) U.S. Cl. 707/200

(57) ABSTRACT

When data is updated in response to execution of an application by a host, an operation center apparatus records update history data into an update history file and updates a database. A remote copy apparatus consisting of network storages transfers and records the update history data via a network into a backup update history file at a transfer destination every time the update history data is recorded into the update history file by the operation center apparatus. When the operation center apparatus goes down, a backup center apparatus restores a management file for managing usage situation of the backup update history file from the backup update history file and, by reference to the management file, sequentially reads out the backup update history file until discontinuity of update history data is identified to update a database for backup.

### BACKGROUND OF THE INVENTION

1. Field of the Invention

The present invention relates generally to a data backup system and method which back up data of an operation center apparatus by use of a backup center apparatus to recover the data when the system goes down by an accidental event such as a disaster and a system failure, and more particularly, to a data backup system and method which back up and recover update history data of a database of the operation center apparatus via a network.

2. Description of the Related Arts

Conventionally, in an operation system which centrally manages process operations of many terminal devices disposed in branches of a company or the like with an operation center apparatus and records these process operations into a database, as a method for maintaining data in preparation for the case that the database can not be utilized because of a disaster, a system failure and the like, a commonly used method is to save the database and update histories of the database into backup external media and evacuate these media to a remote location by means of regularly transportation and a remote location by means of regularly transportation and the like, for example, once a day. Also, as another method, the evacuation is achieved by connecting disks located in the database via a line for creating a duplicate of the database at the remote location (see, e.g., Japanese Patent Application Laid-Open Publication Nos. 1998-293452, 1996-212142, 1997-259023 and 2001-282762).

However, in a conventional method saving the database and update histories of the database into backup external media and evacuating these media to a remote location by means of regularly transportation and the like, an amount of lost data at the time of disaster is determined by an interval of data acquisition for backup, for example, data for one day are lost in the case of transportation once a day, so that lost update data for one day will be recovered by manual entry and vast amounts of time are required for resuming operation after recovering the database. Also, in the case that creating a duplicate of the database at the remote location by copying disks, since data integrity of entire database must be confirmed, vast amounts of time are required for resuming operation after recovering the database.

### SUMMARY OF THE INVENTION

According to the present invention there is provided a data backup system and method which strikes a balance between assurance of data integrity of the database and minimization of the amount of lost data at the time of a disaster, and reduces the amount of time from recovery of the database to resuming of operation. The present invention provides a data backup system. The data backup system of the present invention comprises an operation center apparatus recording update history data into an update history file and updating a database when data is updated in response to execution of an application by a host; a remote copy apparatus transferring and recording the update history data via a network into a backup update history file every time the update history data is recorded into the update history file by the operation center apparatus; and a backup center apparatus recovering a management file for management of the usage situation of the backup update history file from the backup update history file when the operation center apparatus goes down, the backup center apparatus sequentially reading out the backup update history file by reference to the management file until discontinuity of the update block data containing one or more pieces of update data with a block control unit as a header including a block sequence number; and when updating the backup database by use of the update history block data of the backup update history file, the backup center apparatus identifies continuity of the update history block data from the block sequence number so that if continuity exists the backup database is updated and that if no continuity exists update of the backup database is interrupted. For each of the backup update history files, the backup center apparatus generates and records in the management file a file number, a current final block sequence number, a flag indicating presence of the latest used file as management data indicating usage situation of the update history file. The remote copy apparatus provides the operation center apparatus and a transfer destination of the update history data with a network storage apparatus for network interconnection, the network storage apparatus consisting of a remote adaptor to transfer data to a remote location via a network, a device adaptor to process I/O commands from the host and a drive enclosure having a plurality of devices to record and regenerate data in response to execution of the I/O commands of the device adaptor. The network storage apparatus at the host and a drive enclosure having a plurality of devises to record and regenerate data in response to execution of the I/O commands of the device adaptor. The network storage apparatus at the transfer destination may be disposed together with the backup center apparatus, and the network storage apparatus at the transfer destination may be connected via a network to the backup center apparatus that is separately disposed. When it is determined that the operation center apparatus goes down, the backup center apparatus terminates a transfer operation of the remote copy apparatus and confirms contents of the backup update history file. When recovering the management data of the backup update history file, the backup center apparatus associates the management data with an initial backup file stored at the time of startup of the system and with the previously generated management data in order of updating, to record the management data into the management file.

The update history data stored in the update history file are update history block data containing one or more pieces of update data with a block control unit as a header including an update history file number, a block sequence number and a logical time; and for each of the backup update history files the backup center apparatus generates and records usage situation management data containing a backup update history file number, a current final block sequence number, a flag indicating presence of the latest used file.

The present invention provides a data backup method using a remote copy apparatus arranged to transfer data from an operation center apparatus to a backup center apparatus to copy the data into a file. The data backup method of the present invention comprises a database update step of recording update history data into an update history file and updating a database when data is updated in response to execution of an application by a host disposed in the operation center apparatus; a remote copy step of the remote copy apparatus transferring and recording the update history data via a network into a backup update history file every time the update history data is recorded into the update history file; and a backup processing step of, when the operation center apparatus goes down, recovering a management file for management of the usage situation of the backup update history file from the backup update history file and, by reference to the management file, sequentially reading out the backup update history file until discontinuity of the update history data is identified to update a database for backup. It should be noted that details of the data backup method of the present invention are essentially the same as the case of the system.

According to the present invention, by creating a backup update history file which is a copy of an update history file, rather than a database, in a network storage apparatus at a transfer destination which is a remote location, at the time of disaster, only update history data which are recorded and transferred to a backup update history file at that moment are lost, so that the amount of lost data at the time of disaster can be minimized. Also, according to the present invention, by recovering a management file which reads the backup update history file and manages recovery environment, in other words, recovering a management file which manages usage situation of the backup update history file, accessing to the backup update history file which is used for recovery based on information of the management file, reading the update history data until discontinuity is determined and reflecting it upon the database, the update history data can be reflected upon database and recovered while assuring the order. Especially, in an operation center apparatus, in order to minimize effects on performance of operation processes of database update processes, remote copying of the update history data is performed asynchronously to database update. Therefore, update history data with older update time may not be transferred while newer update history data has been transferred, so that the backup update history file may have missing data. Opposed to this, in the present invention, in order to recover the database, reflecting to the database is performed after inspecting continuity of individual update history data based on the recovered management file, and if update history data without continuity appear, by considering that data integrity is assured up to update history data one before those update history data and terminating the reflecting to the database, assured update history data can be reliably and consistently reflected to the database. In this way, the present invention can maintain the integrity of the database at the time of disaster or the like by reflecting assured log data to the database reliably and consistently while minimizing update data which are lost at the time of disaster. The above and other objects, features and advantages of the present invention will become more apparent from the following detailed description with reference to the drawings.

### BRIEF DESCRIPTION OF THE DRAWINGS

FIG. 1 is a block diagram of the configuration of a data backup system of the present invention;

FIG. 2 is a block diagram of the function configuration of the data backup system according to the present invention;

FIG. 3 is an explanatory view of a backup update history file of FIG. 2;

FIG. 4 is an explanatory view of update history block data stored in the backup update history file of FIG. 3;

FIG. 5 is an explanatory view of a recovery management file of FIG. 2;

FIG. 6 is a flowchart of a database update process effected by an operation center apparatus of FIG. 2;

FIG. 7 is a flowchart of a transfer copy process effected by a network storage in the operation center apparatus of FIG. 2; and

FIG. 8 is a flowchart of a backup process in a backup center apparatus of FIG. 2.

### DETAILED DESCRIPTION OF THE PREFERRED EMBODIMENT

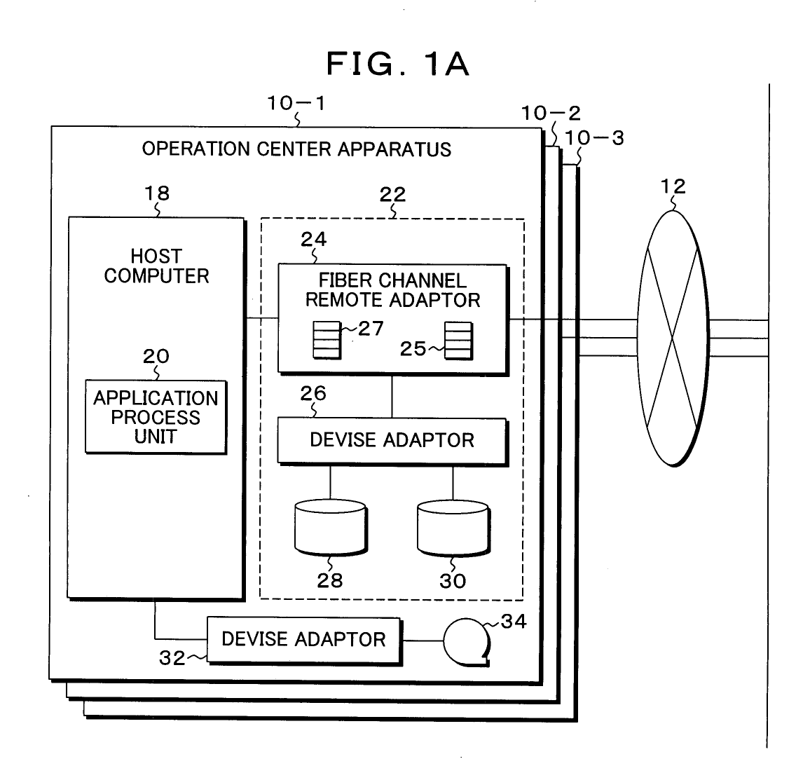

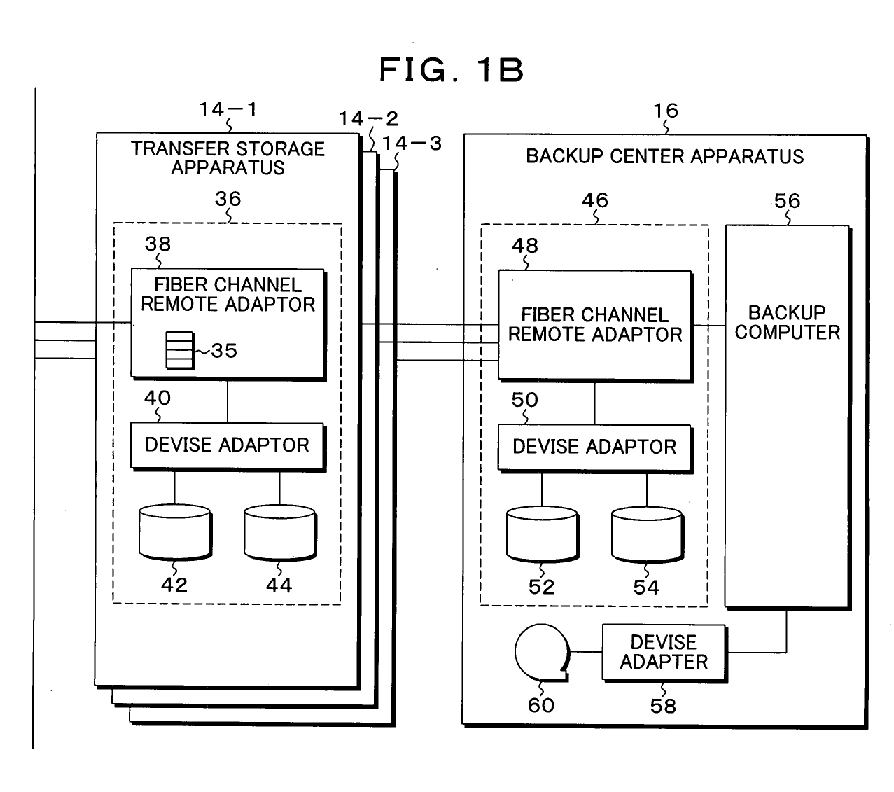

FIG. 1 is a block diagram of a data backup system according to the present invention. In FIG. 1, the data backup system of the present invention consists of operation center apparatuses 10-1, 10-2, 10-3, transfer storage apparatuses 14-1, 14-2, 14-3 and a backup center apparatus 16. In this system configuration, pluralities of operation center apparatuses and transfer storage apparatuses are shown, but these may be configured as one (1) system. The operation center apparatus 10-1 is provided with a host computer 18 and performs transactions with an application process unit 20 which is implementation of an application program. The host computer 18 is provided with network storage 22. The network storage 22 consists of a fiber channel remote adaptor 24, a device adaptor 26 and drive enclosures 28, 30. The fiber channel remote adaptor 24 transfers data to network storage 36 in the transfer storage apparatus 14-1 disposed at remote location via a network 12. The device adaptor 26 processes I/O commands from the host computer which is connected by a channel via the fiber channel remote adaptor 24. The drive enclosures 28, 30 are provided with pluralities of hard disk drives and records data into and regenerates data from the hard disk drives in connection with execution of I/O commands from the device adaptor 26. The pluralities of hard disk drives provided in the drive enclosures 28, 30 are used as databases, update history files and management files, which are discussed in later description of the operation center apparatus 10-1. The host computer 18 is connected with a device for backup 34 via a device adaptor for backup 32, and a magnetic tape apparatus is used as the device for backup 34. The transfer storage apparatus 14-1 is only provided with network storage 36. The network storage 36 consists of a fiber channel remote adaptor 38, a device adaptor 40 and drive enclosures 42, 44, as is the case with the network storage 22 in the operation center apparatus 10-1. Pluralities of hard disk drives provided in the drive enclosures 42, 44 are used as backup update history files, which are discussed in later description. With the network storage 22 provided in the operation center apparatus 10-1 and the network storage 36 provided in the transfer storage apparatus 14-1, a remote copy apparatus in the data backup system of the present invention is configured by interconnection via the network 12. The fiber channel remote adaptor 24 provided in the network storage 22 of operation center apparatus 10-1 is equipped with a transfer queue 25, and the fiber channel remote adaptor 38 provided in the network storage 36 of the transfer storage apparatus 14-1 is also equipped with a transfer queue 35. On the other hand, the fiber channel remote adaptor 24 of the operation center apparatus 10-1 is further equipped with a queue 27 for the device adaptor 26. By using the transfer queue 25 and the queue 27, the fiber channel remote adaptor 24 asynchronously performs writing of update history data into the update history file and update of the database and remote copying, which are performed for each execution of transaction by the application process unit 20. In other words, by inputting the update history data for each execution of transaction by the application process unit 20 into each of the transfer queue 25 and the queue 27, the database update process in the operation center apparatus 10-1 can be performed in parallel without being constrained by the remote copies. Since data transfer via the network 12 with the fiber channel remote adaptors 24, 48 is performed by generating a plurality of virtual communication paths on the application level, the remote copies of the update history data input into the transfer queue 25 are transferred through the plurality of virtual communication paths in parallel to the fiber channel remote adaptor 38 in the transfer storage apparatus 14-1 and stored into the transfer queue 35. Therefore, in the remote copying by the fiber channel remote adaptors 24, 38, if sizes of data are different, a temporally earlier update history file will not necessarily has been transferred first, and a temporally later update history file may has been transferred first and recorded on the backup update history file on the side of the transfer storage apparatus 14-1. In this embodiment, the backup center apparatus 16 is provided with network storage 46 and, via the network storage 46, a backup computer 56. That is, in the system configuration of FIG. 1, the backup center apparatus 16 is disposed at different location from the transfer storage apparatuses 14-1 to 14-3, and private lines connect between them for this system configuration. Naturally, the transfer storage apparatuses 14-1 to 14-3 can be disposed at the same location as the backup center apparatus 16. In this case, the fiber channel remote adaptor 48 is not necessarily needed on the side of the backup center apparatus 16, and a channel adaptor which can be connected with the fiber channel remote adaptors 38 of the network storage apparatuses 14-1 to 14-3 may be used. The backup computer 56 builds up a backup database and a management file which are used for backup processes when system down and functional breakdown are caused on the side of the operation center apparatuses 10-1 to 10-3 by disasters and system failures, with a plurality of hard disk drives provided in drive disk enclosures 52, 54 of the network storage. The backup computer 56 is provided with a device adaptor for backup 58, and the device adaptor for backup 58 is connected with, for example, a magnetic tape apparatus as a device for backup 60. In the device for backup 60, initial backup media which are created by the device for backup 34 of the operation center apparatus 10-1 are set by physical transportation for retrieving initial backup at the time of recovering the backup database.

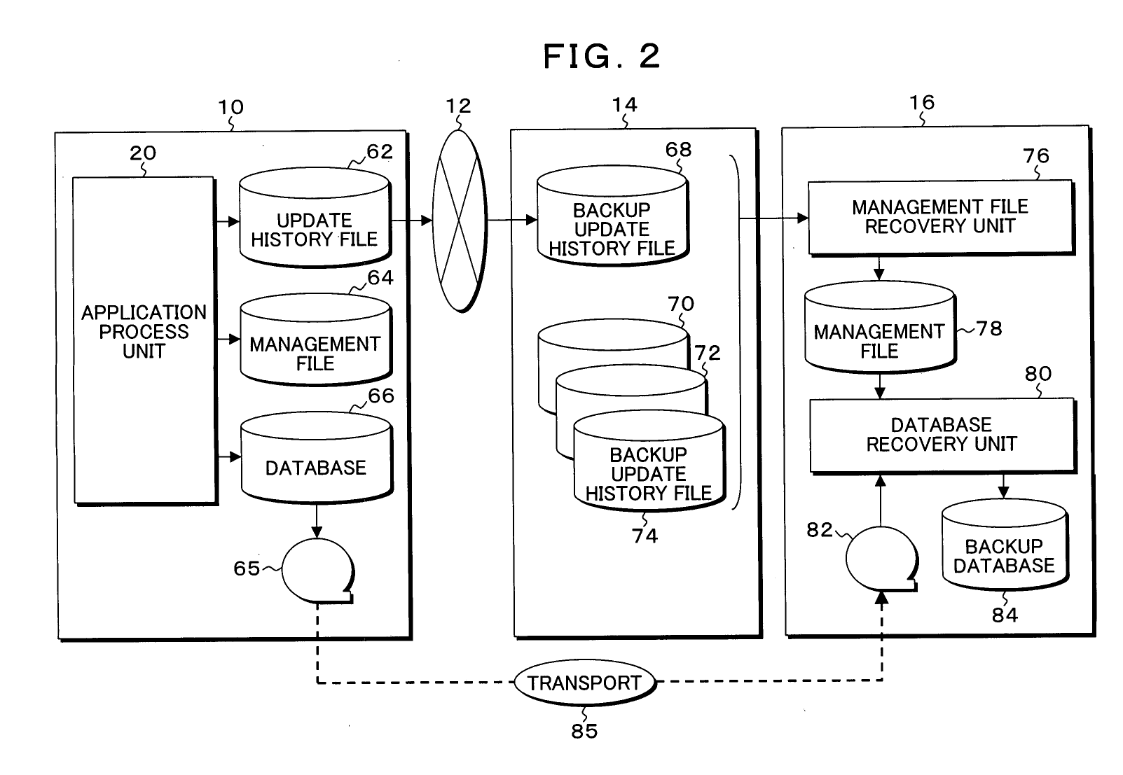

FIG. 2 is a block diagram of a functional configuration of a data backup system according to the present invention. In FIG. 2, the operation center apparatus 10 is provided with an application process unit 20, an update history file 62, a management file 64, a database 66 and an initial backup 65. The transfer storage apparatus 14 is provided with backup update history files 68, 70, 72, 74, and the backup update history file 68 is currently used. The backup center apparatus 16 is provided with a management file recovery unit 76, a recovery management file 78, a database recovery unit 80, an initial backup 82 and a backup database 84. If the database 66 is updated in the operation center apparatus 10, in case of destruction of the database 66 caused by disasters or the like, the update history file 62 storing update history data is provided. For the update history data stored in the update history file 62, the update history data are stored in the update history file 62 for each transaction, which is a meaningful database update unit in the application process unit 20. The update history file 62 can be disposed as a plurality of files, and when one file becomes full, a storage place of the data is switched to the next update history file. After the update history data obtained from execution of a transaction of the application process unit 20 are stored in the update history file 62, the database 66 is updated with the update history data. In the management file 64, usage situations of the update history file 62 are registered, and by referring to the management file 64, the application process unit 20 performs storage of the update history data into the currently used update history file 62 and update of the update history data in the database 66. When the update history data associated with execution of a transaction are stored into the update history file 62 of the operation center apparatus 10, remote copy to the transfer storage apparatus 14 disposed at remote location is performed for transferring and recording identical update history data via the network 12. The remote copy of the update history data is transferred physically and asynchronously with the processes which updates the database 66 of the operation center apparatus 10 for each transaction, and is recorded in the backup update history file 68 of the transfer storage apparatus 14 which is a transfer destination. In order to perform the remote copy of the update history file, a process function for the remote copy to the transfer storage apparatus 14 must has been in a start status before recording of data into the update history file 62 in the operation center apparatus 10, and specifically, the remote copy start status has been initiated by inputting a remote copy status starting command. It should be noted that, out of a plurality of the backup update history files 68, 70, 72, 74, the backup update history files 68 is a file into which the update history data are currently recorded by the remote copy, and other backup update history files 70, 72, 74 are files in which the date are already recorded. In this situation of transferring and storing the update history data for each transaction using the remote copy function from the operation center apparatus 10 to the transfer storage apparatus 14, if all of the functions in the operation center apparatus 10 are broken down by a disaster or the like, transferring for the remote copy of the update history data is disrupted. To enable the recovery process by reading the backup update history file 68 of the transfer destination from the situation that the transfer of the remote copy is disrupted, the transfer storage apparatus 14 side is set to a remote copy cancel status corresponding to the disruption of the transfer of the remote copy, and details of the backup update history file 68 are confirmed. Specifically, by inputting a remote copy canceling command from the side of the backup center apparatus 16, the remote copy transfer to the currently recording backup update history file 68 is disrupted and details of the file is confirmed. After the remote copy transfer is disrupted in this manner, in order to recover a database which has the same contents as the database 66 on the side of the operation center apparatus 10 using the backup update history file 68, 70, 72, 74 of the transfer storage apparatus 14, the management file recovery unit 76 restores the management file 78 indicating in what order the backup update history file 68, 70, 72, 74 are recorded. The management file 78 is a file recording management data about usage situations of the backup update history file 68, 70, 72, 74, and by reference to the management file 78, the backup update history file 68 can be identified at the access destination when the backup database 84 is updated. Specifically, in the management data recovered into the management file 78, file numbers, sequence numbers of a data blocks currently recorded in the file, flags indicating presence of the latest used file and the like are stored for each of the backup update history files 68, 70, 72, 74. The database recovery unit 80 refers to the recovered management file 78 and associates a reading order of the newly recovered management file 78 with the initial backup file and previously recovered management files (not shown). Then by targeting the backup update history files which is not updated yet, reading out update history data in updated order and reflecting the data to the backup database 84, the backup database 84 is recovered. The update history data just before functional breakdown of the operation center apparatus 10 is not necessarily transferred to the backup update history file 68 of the transfer storage apparatus 14 by the remote copy. Therefore, the update history data recorded on the backup update history file 68 are physically discontinuous and defective data. Therefore, when reading out the update history data from the backup update history file 68 which is a target of the recovery and reflecting the data to the backup database 84, the database recovery unit 80 determines discontinuity of the update history data and stops reflecting the update history data to the backup database 84 at the time when the discontinuity is detected, and thereby, the recovery of the database is performed in the range that the update history data is ensured. According to this data backup process of the present invention, when functions of the operation center apparatus 10 are halted by a disasters or the like, the update history data waiting to be transferred by the remote copy in the operation center apparatus 10 are only lost, and an amount of data lost at the time of disaster can be minimized. In the recovery process of the backup center apparatus 16 when the functions of the operation center apparatus 10 are halted, for the backup update history file 68 used in the transfer storage apparatus for the remote copy, a database is recovered by identifying a range of the update history data in which the data integrity can be ensured from determination of the discontinuity of the update history data and by reading out the update history data from that range. In this way, the backup center apparatus 16 restores the backup database 84 in short period of time after unforeseen disasters or system failures, and by utilizing the recovered backup database 84, operations of the operation center apparatus 10 can be resumed in short period of time.

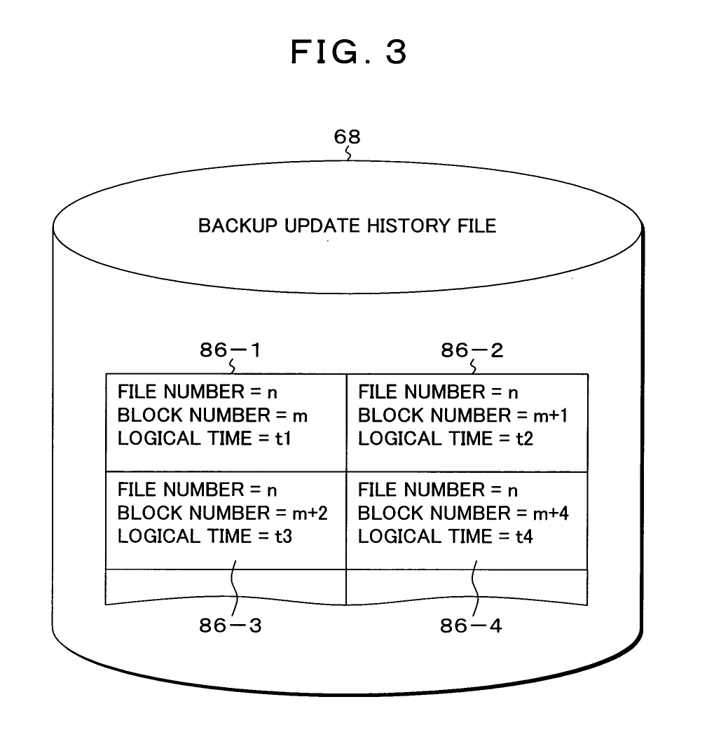

FIG. 3 is an explanatory view of the backup update history file 68 of FIG. 2. The backup update history file 68 receives and records data from the remote copy in units of block data 86-1, 86-2, 86-3, 86-4 which are the update history data. In each of the block data 86-1, 86-2, 86-3, 86-4, a file number, a block number and logical time are stored in a block control unit provided as a header, and the order of the block data 86-1 to 86-4 can be determined from the block numbers.

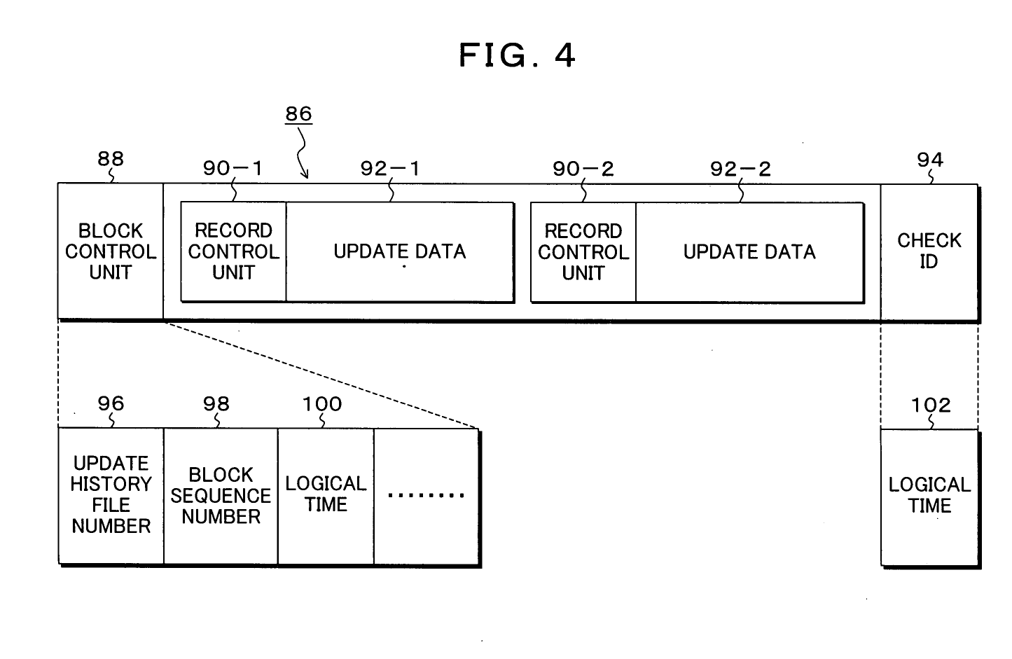

FIG. 4 is an explanatory view of update history block data recorded in the backup update history file 68 of FIG. 3. In the update history block data 86 of FIG. 4, a block control unit 88 is arranged as a header unit, which is followed by a record control unit 90-1 with update data 92-1 and a record control unit 90-2 with update data 92-2. In this example, two update history data are arranged and a check ID 94 is provided at the end. The block control unit 88, which acts as a leading header, is provided with header information including an update history file number 96, a block sequence number and logical time 100, as taken out and shown on the downside. It should be noted that the check ID 94 at the end of the update history block data 86 includes logical time 102, as taken out and shown on the downside.

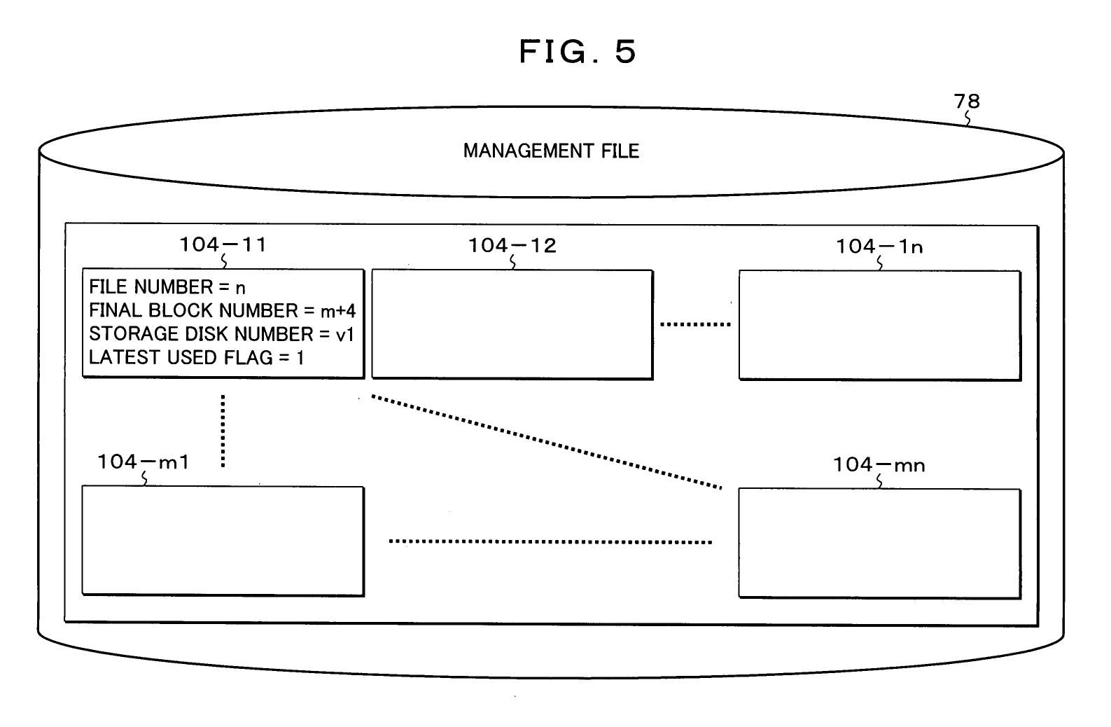

FIG. 5 is an explanatory view of a management file recovered in the backup center apparatus 16 of FIG. 2. In the management file 78, management data 104-11 to 104-mn are recorded in units of the update history file. Details of the management data 104-11 are illustrated here, and a file number=n of the history management file, a final block number=m+4 indicating to what number the block sequence numbers has been used in the history management file identified by this file number=n, a storage disk number=v1 and a latest used flag=1 indicating that this file is the currently used latest update history file are recorded. By the database recovery unit 80 of FIG. 2 referring to the management file 78 which has these management data 104-11, information of the backup update history file 68 needed to recover the backup database 84 is obtained, and the recovery is performed by reading out the history management data needed for the recovery and writing the data into the backup database 84.

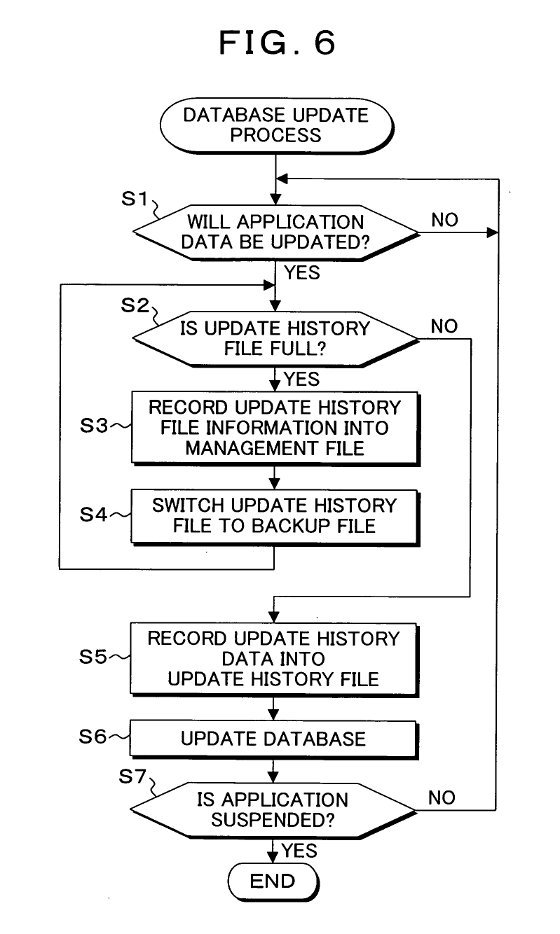

FIG. 6 is a flowchart of a database update process in the operation center apparatus of FIG. 2. In FIG. 6, the application process unit 20 checks whether data will be updated in response to execution of a transaction or not in step S1, and if it is decided that the data will be updated in response to execution of a transaction, it is checked whether the update history file is full or not in step S2. If the file is not full, the procedure proceeds to step S5 to record the update history date into the update history file 62 and then proceeds to step S6 to update the database 66. Then, in step S7, it is checked whether a process of the application process unit 20 is suspended or not is checked, and the processes started from step S1 are repeated until the process is suspended. On the other hand, if the update history file 62 is full when trying to record the update history data in step S2, the procedure proceeds to step S3 to record information of the update history file 62 which has been full, then proceeds to step S4 to prepare new update history file by switching the update history file to a spare file and returns to step S2 to check whether the update history file is full or not, and since the file is not full if the file has been switched, the update history data is recorded into the switched update history file.

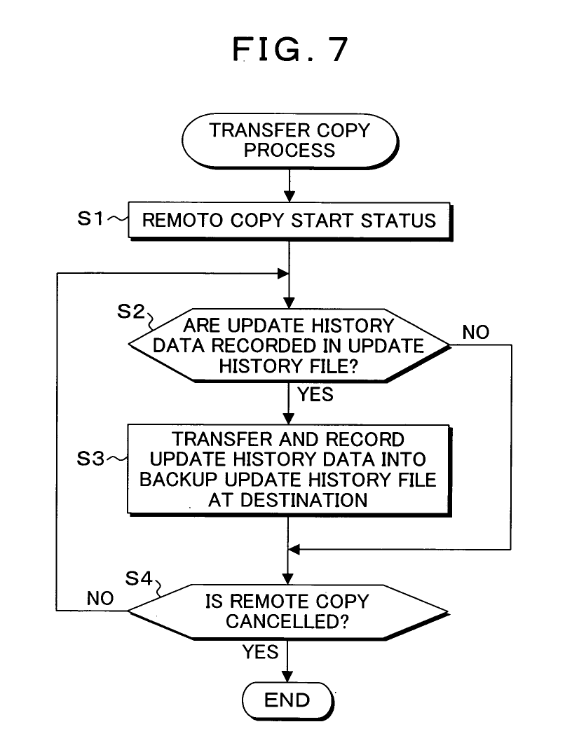

FIG. 7 is a flowchart of a remote copy process in the operation center apparatus 10 of FIG. 2. Specifically, the remote copy process is performed by the network storage 22 of the operation center apparatus 10-1 shown in FIG. 1. In the remote copy process of FIG. 7, a remote copy start status is achieved by inputting a remote copy start status command in step S1. Then, in step S2, it is checked whether the update history data is recorded into the update history file or not, and if an input for recording is requested, the update history data are transferred via the network 12 and recorded into the backup update history file 68 of the transfer storage apparatus 14 which is a transfer destination, in step S3. Then, in step S4, it is checked whether the remote copy is cancelled or not, or specifically, whether a remote copy cancel command is input or not, and the processes started from step S2 are repeated until it is decided that the remote copy is cancelled.

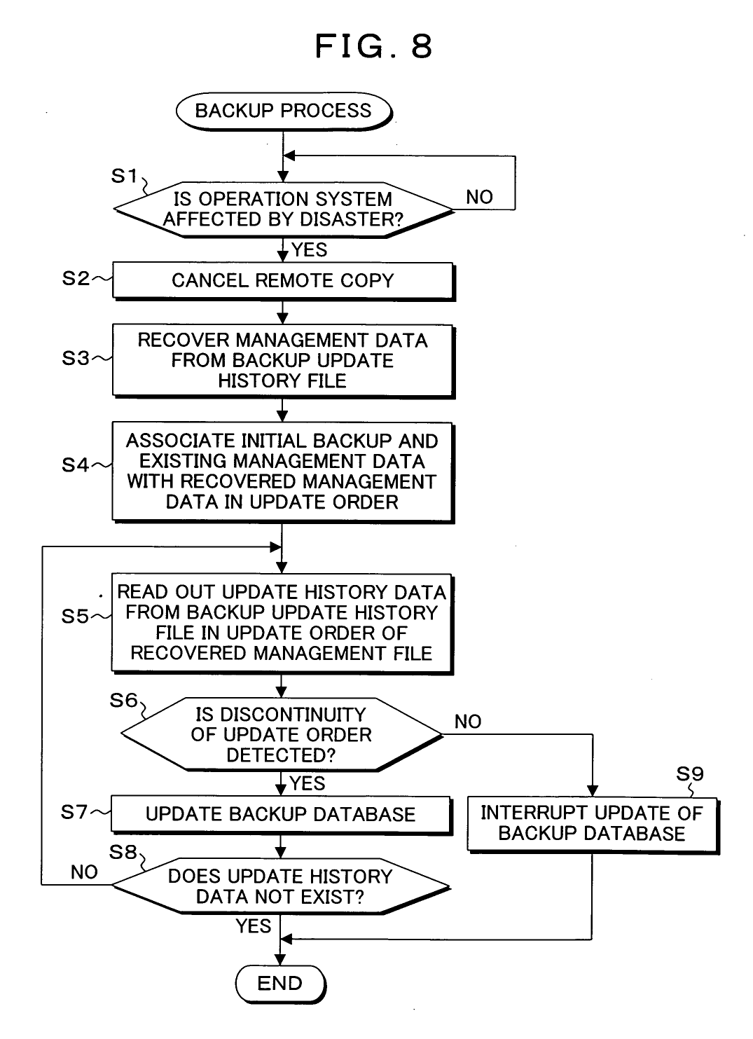

FIG. 8 is a flowchart of a backup process in the backup center apparatus of FIG. 2. In FIG. 8, if it is decided that functional breakdown of the operation center apparatus 10 is caused by a disaster in step S1, contents of the currently recording backup update history file 68 are confirmed by inputting the remote status cancel command to the transfer storage apparatus 14 side for canceling the remote copy in step S2. Then, in step S3, management data are recovered from the backup update history file 68 and recorded into the management file 78. Then, in step S4, the management data of the initial backup 82 and the management file are associated with the management data of the recovered management file 78 in update order. Subsequently, in step S5, update history data are read out from the backup update history file 68 in update order of the recovered management file 78. In the update history data, as shown in the update history block data 86 of FIG. 4, since the headmost block control unit 88 as a header is provided with the block sequence number 98, whether discontinuity of the update order of the update history data is detected or not is checked in step S6 by checking the block sequence number 98. If continuity is detected from the block sequence number, the procedure proceeds to step S7 to update the backup database 84 with the currently read update history data. Then, in step S8, it is checked whether the update history data exist or not, and the processes started from step S5 are repeated until the update history data disappear. During the update of the backup database with reading out of the update history data, in step S6, if discontinuity, which means that discontinuity exits between the block sequence number of the currently read update history data and the block sequence number of previous update history data, is detected, the procedure proceeds to step S9 to interrupt the update of the backup database and terminate the process. It should be noted that the network storage 22, 36 for the remote copy may be duplicated for ensuring credibility of the remote copy. The present invention encompasses any alterations without impairing the object and the benefit thereof and is not restricted by the numerical values shown in the above embodiment.

What is claimed is:

1. A data backup system comprising:
an operation center apparatus recording update history data into an update history file and updating a database when data is updated in response to execution of an application by a host;
a remote copy apparatus transferring and recording the update history data via a network into a backup update history file every time the update history data is recorded into the update history file by the operation center apparatus; and
a backup center apparatus recovering a management file for management of the usage situation of the backup update history file from the backup update history file when the operation center apparatus goes down, the backup center apparatus sequentially reading out the backup update history file by reference to the management file until discontinuity of the update history data is identified, for updating of a database for backup.

2. The data backup system of claim 1, wherein
the update history data stored in the update history file are update history block data containing one or more pieces of update data with a block control unit as a header including a block sequence number, and wherein
when updating the backup database by use of the update history block data of the backup update history file, the backup center apparatus identifies continuity of the update history block data from the block sequence number so that if continuity exists the backup database is updated and that if no continuity exists update of the backup database is interrupted.

3. The data backup system of claim 1, wherein for each of the backup update history files, the backup center apparatus generates and records in the management file a file number, a current final block sequence number, a flag indicating presence of the latest used file as management data indicating usage situation of the update history file.

4. The data backup system of claim 1, wherein the remote copy apparatus provides the operation center apparatus and a transfer destination of the update history data with a network storage apparatus for network interconnection, the network storage apparatus consisting of a remote host and a drive enclosure having a plurality of devices to record and regenerate data in response to execution of the I/O commands of the device adaptor.

5. The data backup system of claim 4, wherein the network storage apparatus at the transfer destination is disposed together with the backup center apparatus.

6. The data backup system of claim 4, wherein the network storage apparatus at the transfer destination is connected via a network to the backup center apparatus that is separately disposed.

7. The data backup system of claim 1, wherein when it is determined that the operation center apparatus goes down, the backup center apparatus terminates a transfer operation of the remote copy apparatus and confirms contents of the backup update history file.

8. The data backup system of claim 1, wherein when recovering the management data of the backup update history file, the backup center apparatus associates the management data with an initial backup file stored at the time of startup of the update history file, the backup center apparatus associates the management data with an initial backup file stored at the time of startup of the system and with the previously generated management data in order of updating, to record the management data into the management file.

9. A data backup method using a remote copy apparatus to transfer data from an operation center apparatus to a backup center apparatus to copy the data into a file, comprising:
a database update step of recording update history data into an update history file and updating a database when data is updated in response to execution of an application by a host disposed in the operation center apparatus;
a remote copy step of the remote copy apparatus transferring and recording the update history data via a network into a backup update history file every time the update history data is recorded into the update history file; and
a backup processing step of, when the operation center apparatus goes down, recovering a management file for management of the usage situation of the backup update history file from the backup update history file and, by reference to the management file, sequentially reading out the backup update history file until discontinuity of the update history data is identified to update a database for backup.

10. The data backup method of claim 9, wherein
the update history data stored in the update history file are update history block data containing one or more pieces of update data with a block control unit as a header including a block sequence number, and wherein
when updating the backup database by use of the update history block data of the backup update history file, the backup center apparatus identifies continuity of the update history block data from the block sequence number so that if continuity exists the backup database is updated and that if no continuity exists update of the backup database is interrupted.

11. The data backup method of claim 9, wherein for each of the backup update history files, the backup center apparatus generates and records in the management file a file number, a current final block sequence number, a flag indicating presence of the latest used file as management data indicating usage situation of the update history file.

12. The data backup method of claim 9, wherein, when it is determined that the operation center apparatus goes down, the backup processing step terminates a transfer copy operation for the update history data and confirms contents of the backup update history file.

13. The data backup method of claim 9, wherein the backup processing step includes, when recovering the management data from the backup update history file, associating the management data with an initial backup file stored at the time of startup of the system and with the previously generated management data, to record the management data into the management file.

14. The data backup method of claim 9, wherein
the update history data stored in the update history file are update history block data containing one or more pieces of update data with a block control unit as a header including an update history file number, a block sequence number and a logical time, and wherein
the backup processing step includes, for each of the backup update history files, generating and recording usage situation management data containing a backup update history file number, a current final block sequence number, a flag indicating presence of the latest used file.

15. A data backup program operable to drive a remote copy apparatus transferring data from an operation center apparatus to a backup center apparatus for copying the data into a file to execute:
a database update step of recording update history data into an update history file and updating a database when data is updated in response to execution of an application by a host disposed in the operation center apparatus;
a remote copy step of the remote copy apparatus transferring and recording the update history data via a network into a backup update history file every time the update history data is recorded into the update history file; and
a backup processing step of, when the operation center apparatus goes down, recovering a management file for management of the usage situation of the backup update history file from the backup update history file and, by reference to the management file, sequentially reading out the backup update history file until discontinuity of the update history data is identified to update a database for backup.
